(19) United States
(12) Patent Application Publication
(10) Pub. No.: US 2017/0291374 A1
(43) Pub. Date: Oct. 12, 2017

(54) 3D PRINTED PARTS WITH SUPPORT REMOVAL CLEANER

(71) Applicant: Brent C. Mosher, Brooklyn Park, MN (US)

(72) Inventor: Brent C. Mosher, Brooklyn Park, MN (US)

(21) Appl. No.: 15/483,628

(22) Filed: Apr. 10, 2017

Related U.S. Application Data
(60) Provisional application No. 62/320,248, filed on Apr. 8, 2016.

(51) Int. Cl. B29C 67/00; C08J 11/08; B33Y 40/00

(52) U.S. Cl. CPC B29C 67/0096; B29C 67/0092; B33Y 40/00; C08J 11/08; B33Y 70/00

(57) ABSTRACT

A system, methods, and chemical compositions for removing a support structure material from a printed material during 3D printing are described. The printing material may include polyetherimide or polyetherimide alloy. The support structure material may include polysulfone or polyethersulfone. A solvent for dissolving the support structure material may include one or more of N-propyl bromide, 1,2 butylene oxide, and N-methyl-2-pyrrolidone.

This application claims the benefit of U.S. Provisional Application No. 62/320,248, filed Apr. 8, 2016, the contents of which are herein incorporated by references.

### BACKGROUND

Three-dimensional (3D) printers are becoming popular for rapidly prototyping products. 3D printers are able to create a solid 3D object from a digital model, such as a computer aided design (CAD) model. 3D printers often use a polymer-based material to create the object. The polymer is normally disposed in layers, such that the object is built up. The polymer is heated to be in at least in a partially liquid form when it is disposed in it desired location. The polymer can take some time to cool and become rigid. In some cases, a support structure, such as scaffolding, is printed along with the object to provide support for at least a portion of the object while the printed object cools and becomes rigid.

Fused deposition modeling (FDM) is one technique for making 3D printed objects. This technique is one type of process in the category of additive manufacturing. This process is described in U.S. Pat. No. 5,121,329 to Crump, entitled “Apparatus and Method for Creating Three-Dimensional Objects,” and which is hereby incorporated by reference in its entirety. This process works by heating a thermoplastic manufacturing material, then depositing the heated manufacturing material on a base plate in layers. The manufacturing material remains heated, and thus pliable, throughout the printing process. Some examples of thermoplastic materials include polyamides (nylon), acrylonitrile butadiene styrene (ABS), polylactic acid (PLA), metals, biological materials, and polyetherimide (PEI) and polyetherimide alloy.

Two such polyethermides are sold under the brand names Ultem 9085 and Ultem 1010. These materials are especially useful in aerospace, automotive, mold making, and casting applications where high strength, chemical resistance, and fire resistance are required.

To prevent overhanging sections of the printed part from being pulled down by the force of gravity, a support material is laid alongside the manufacturing material to support the layers above from being distorted while the manufacturing material is still pliable. The support material is made of a different substance than the manufacturing material. Some examples of support materials include polymers such as polyphenylsulfone, polystyrene, polyethersulfone and polysulfone.

When the 3D printed object is completed, the manufacturing material and the support material remain in contact with one another. The support material must be removed so that the 3D printed object can be used for its intended function. The support structure can be removed, such as by cutting or dissolving the support structure. In some cases the object can be submerged in a chemical solvent that dissolves the support structure.

One method of removing the support material is to physically break the material from the manufacturing material. This technique is sometimes called break away support structure (BASS). This process is described in U.S. Pat. No. 5,503,785 to Crump et. al, entitled “Process of Support Removal for Fused Deposition Modeling,” and which is hereby incorporated by reference in its entirety.

Another method of removing the support material is to completely or partially dissolve the support material in a chemical substance, then physically remove the support material from the manufacturing material. Some support materials are water-soluble, while others are soluble in other chemical solvents. A need has arisen for simplifying the removal of support structure material from polyetherimide and polyetherimide alloy, sold under the brand names Ultem 1010 and Ultem 9085, respectively. Currently, the most common support structure for Ultem 1010 and Ultem 9085 are BASS materials. But using a breakaway support structure is laborious and time consuming. It would be advantageous to introduce a chemical solvent for dissolving the support structures when printing with Ultem 1010 and Ultem 9085. Using a soluble support structure decreases the need for human intervention when removing the support structure. It also decreases the time and labor required for removal of the support structure. Accordingly, there is a need for a chemical solvent to dissolve support structures quickly and effectively.

### SUMMARY OF THE DISCLOSURE

Accordingly, the current disclosure provides systems, methods, and chemical compositions providing a soluble support structure for polyetherimide and polyetherimide alloy when used for 3D printing. The 3D printer may operate using an FDM technique, however, it is contemplated that the disclosed systems and methods could be used in conjunction with other 3D printing techniques, and the disclosure is not constrained to be used only with FDM.

One embodiment includes a method of forming an object using a 3D printer. The method comprises depositing a first material to create a support structure for a second material; depositing the second material onto the support structure; using a solvent to dissolve at least a portion of the first material without affecting the physical properties of the second material; and removing at least a portion of the dissolved first material from the second material such that the first material no longer supports the second material, wherein the first material comprises polyethersulfone, the second material comprises polyetherimide, and the solvent comprises N-methyl-2-pyrrolidone.

In some embodiments, the solvent comprises between 60-100% N-methyl-2-pyrrolidone and between 0-40% carrier solvents by volume. The carrier solvents may include mineral spirits, for example, aliphatic hydrocarbon having a flash point of 140 degrees Fahrenheit.

In some embodiments, the step of using the solvent to dissolve the first material includes exposing the first material to the solvent for between about two to nine hours. In some embodiments, the step of using a solvent to dissolve the first material is performed at a temperature below 100 degrees Fahrenheit. In some embodiments, the step of using a solvent to dissolve the first material is performed at a temperature below 85 degrees Fahrenheit. In some embodiments, a hemispherical oscillating spray apparatus is used to directly spray the solvent on the first material, exposing the first material to the solvent for about two to nine hours, wherein the first material is dissolved and removed without manual human intervention. The hemispherical spray may be submerged for part of the time and not submerged for other times (a combination) the hemispherical spray is also impacting the part in a 360 degree fashion, and some aspect of the impact will oscillate (either the basket will turn or the spray bars will turn) to hit the part in all 360 degree.

Other types of parts washers will also work with this invention (moving table, fixed spray, vortex mixing, etc.) but hemispherical is generally most effective.

Another embodiment includes a method of forming an object using a 3D printer, the method comprising depositing a first material to create a support structure for a second material; depositing the second material onto the support structure; using a solvent to dissolve at least a portion of the first material without affecting the physical properties of the second material; and removing at least a portion of the dissolved first material from the second material such that the first material no longer supports the second material; wherein the first material comprises polysulfone, the second material comprises polyetherimide alloy, and the solvent comprises N-propyl bromide. In some embodiments, the solvent comprises about between 60-100% N-propyl bromide and about between 0-40% carrier solvents by volume. The carrier solvents may include mineral spirits, for example, aliphatic hydrocarbon having a flash point of 140 degrees Fahrenheit. In some embodiments, the solvent may also include up to 3% 1,2 butylene oxide by volume. In some embodiments, the step of using the solvent to dissolve the first material includes exposing the first material to the solvent for between about two to nine hours. In some embodiments, the step of using a solvent to dissolve the first material is performed at a temperature below 100 degrees Fahrenheit. In some embodiments, the step of using a solvent to dissolve the first material is performed at a temperature below 85 degrees Fahrenheit. In some embodiments, a hemispherical oscillating spray apparatus is used to directly spray the solvent on the first material; exposing the first material to the solvent for about two to nine hours, wherein the first material is dissolved and removed without manual human intervention.

In another aspect, the disclosure presents a chemical solvent for dissolving a polyethersulfone support structure used in three-dimensional printing, the solvent comprising between about 60-100% N-methyl-2-pyrrolidone and between about 0-40% carrier solvents by volume.

In another aspect, the disclosure presents a chemical solvent for dissolving a polysulfone support structure used in three-dimensional printing, the solvent comprising between about 60-100% N-propyl bromide and between about 0-40% carrier solvents by volume. The chemical solvent may further contain up to 3% 1,2 butylene oxide by volume.

In another aspect, a system is presented for creating a three-dimensional printed object. The system includes a thermoplastic material, a soluble support material creating a scaffolding structure for the thermoplastic material, a 3D printer for creating the scaffolding structure from the soluble support material, and a chemical solvent for dissolving the soluble support material. In one embodiment, the thermoplastic material is polyetherimide, the soluble support material is polyethersulfone, and the chemical solvent contains N-methyl-2-pyrrolidone. In another embodiment, the thermoplastic material is polyetherimide alloy, the soluble support material is polysulfone, and the chemical solvent contains N-propyl bromide; in this embodiment the chemical solvent may also contain 1,2 butylene oxide.

A further aspect of the disclosure provides a method for reusing a soluble support material for use in three-dimensional printing. The method comprises: dispensing polysulfone to make a scaffolding structure; dispensing a polyetherimide alloy on the scaffolding structure; dissolving the polysulfone scaffolding structure using a solvent containing N-propyl bromide; collecting the dissolved polysulfone; drying the collected polysulfone; and recycling the dried polysulfone. In this embodiment, the solvent may also include 1,2 butylene oxide. This method may be performed at a temperature below 100 degrees Fahrenheit. The step of recycling the dried polysulfone may also include providing the dried polysulfone to another entity, wherein the other entity, such as a dedicated recycling facility, performs the chemical treatment necessary to reuse the polysulfone.

Another aspect of the disclosure provides a method for forming a three-dimensional object having overhanging portions freely suspended in space, the method comprising: providing a support structure made of at least one of polysulfone and polyethersulfone; depositing at least one of polyetherimide and polyetherimide alloy on the support structure to create a supported printed object; dissolving at least a portion of the supported printed object using a chemical solvent; and removing the support structure from the supported printed object after the dissolving step. In one embodiment, polyetherimide alloy is deposited on the support structure and the chemical solvent contains N-methyl-2-pyrrolidone. In this embodiment the polyetherimide alloy is dissolved and removed from the supported printed object.

This summary is an overview of some of the teachings of the present application and is not intended to be an exclusive or exhaustive treatment of the present subject matter. Further details are found in the drawings, specification, and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE FIGURES

The disclosure may be more completely understood in connection with the following drawings, in which:

FIG. 1 is a schematic diagram of a 3D printer according to an embodiment.

FIG. 2A is a perspective view of a 3D printed part before the support structure has been removed, according to an embodiment.

FIG. 2B is a perspective view of a 3D printed part after the support structure has been removed, according to an embodiment.

FIG. 3A is a perspective view of a system to remove a support structure from a 3D printed part, according to an embodiment.

FIG. 3B is a perspective view of a hemispherical oscillating spray apparatus, according to an embodiment.

FIG. 3C is a perspective view of a system to remove solid particles of support structure material from liquid chemical solvent, so that the support structure material can be recycled and reused, according to an embodiment.

FIG. 3B is a perspective view of a system to remove dissolved support structure material from liquid chemical solvent, so that the support structure material can be recycled and reused, according to an embodiment.

FIG. 4 is a flow chart of a method for forming an object using a 3D printer, according to an embodiment.

FIG. 5 is a flow chart of a method for reusing a soluble support material for use in 3D printing, according to an embodiment.

FIG. 6 is a flow chart of a method for forming a three-dimensional object having overhanging portions freely suspended in space, according to an embodiment.

While the invention is susceptible to various modifications and alternative forms, specifics thereof have been shown by way of example and drawings, and will be described in detail. It should be understood, however, that the disclosure is not limited to the particular embodiments described. On the contrary, the intention is to cover modifications, equivalents, and alternatives falling within the spirit and scope of the claims.

### DETAILED DESCRIPTION

The present embodiments described herein are not intended to be exhaustive or to limit the claims to the precise forms disclosed in the following detailed description. Rather, the embodiments are chosen and described so that others skilled in the art can appreciate and understand the principles and practices of the claimed subject matter.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

When printing an FDM structure out of Ultem 9085 or Ultem 1010 material, a support structure must be printed in tandem with the desired part. Currently the support structure material, which acts as scaffolding, must be removed by breaking it off. This is time consuming and labor intensive. Furthermore, some part designs will not allow access to interior spaces to break away the support structure material.

The disclosed embodiments use a solvent formula and equipment set that results in removal of the support structure material without diminishing the physical properties of the Ultem printed part, including fire rating, structural integrity, and high temperature resistance.

When used with appropriate equipment, this novel chemical solvent will allow the user to minimize the time required to remove the support structure material, reduce manpower, and allow more complex parts to be printed out of Ultem 9085 and Ultem 1010 materials without damaging the printed part.

In some embodiments, the support structure is readily removed using specialized equipment, such as a system that maintains the solution level at about half the total height of the tank. The head space above the solution level is chilled to create a cold blanket about the solution to prevent evaporative loss of the solvent. In some embodiments, the parts are fixed to a basket that moves up and down during processing. One side of tank is filled with spray bars that create a direct flow impingement to push material off the part. The opposite side of spray bars is a filter design to collect the support material for easy removal.

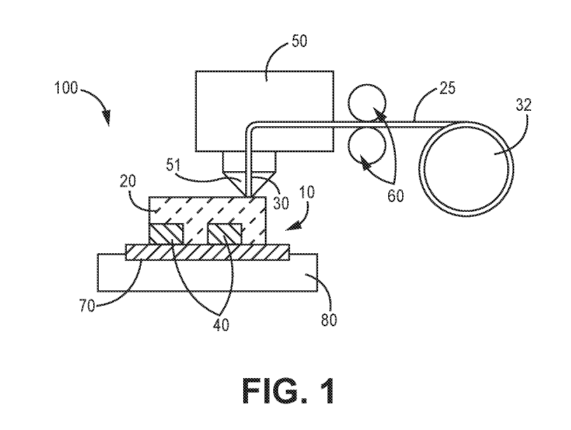

FIG. 1 is a schematic diagram of a 3D printer according to an embodiment. The system 100 of FIG. 1 includes a 3D printer 50. The printer 50 may be a conventional FDM 3D printer, such as one of the printers sold by Stratasys Ltd. under the trade name Fortus 400mc, Fortus 450mc or Fortus 900mc. However, other 3D printers could be used, as long as the printer 50 has the capability to process the part material and support material as disclosed in this specification.

The printer 50 has a movable dispensing head 51 which has a heated tip 30. A printing material 25 is fed through rollers 60 and dispensed through the heated tip 30. The heated tip 30 may for example reach a temperature of 380 degrees Celsius. The thermoplastic resin 25 may be extruded from the tip 30 at a temperature of about 330 to 360 degrees Celsius. During FDM additive manufacturing, the dispensing head 51 is movable in the X, Y, and Z directions relative to a base plate 70, which is supported by the base 80 of the 3D printer. The thermoplastic resin 25 is deposited alongside and on top of the support material 40 onto a baseplate 70. The printing material 25 is laid down in layers. The dispensing head 51 dispenses printing material 25 in a thin layer along the X-Y axis. Where necessary to support the final printed object, the 3D printer lays down support structure material 40 to provide a scaffolding-like structure to prop up the printing material 25 during printing. The support structure material 40 is shown in FIG. 1 supporting the printed object 20. After the support structure material 40 has been laid down, the printing material 25 can be dispensed over the material 40 and supported by the support structure.

The printing material 25 may be a thermoplastic resin. More particularly, the printing material 25 may be a polyetherimide or polyetherimide alloy, sold under the trade names Ultem 1010 and Ultem 9085, respectively.

In one embodiment, the printing material 25 is Ultem 1010 (polyetherimide), and the support structure material 40 is polyethersulfone, which is sold under the trade name “Ultem 1010 Support Material.” The polyetherimide may be of the type designated CAS-No. 61128-46-9. The polyethersulfone may be of the type designated CAS-No. 25667-42-9.

In another embodiment, the printing material 25 is Ultem 9085 (polyetherimide alloy), and the support structure material 40 is polysulfone, which is sold under the trade name “Ultem 9085 Support Material.” The polysulfone may be of the type designated CAS-No. 25154-01-2.

During the duration of the printing process, the printing material 25 and the support structure material 40 remain very warm. After the printing is complete, the printed supported object 10, which is the combination of the printing material 25 and the support structure material 40, must be cooled and hardened before the 3D printed object can be used.

It should be noted that the 3D printer also has a movable dispensing head for dispensing a support structure material 40. The operation and features of the dispensing head for the support structure material 40 is similar to that of the one for the thermoplastic resin 25, as one of ordinary skill in the art will understand.

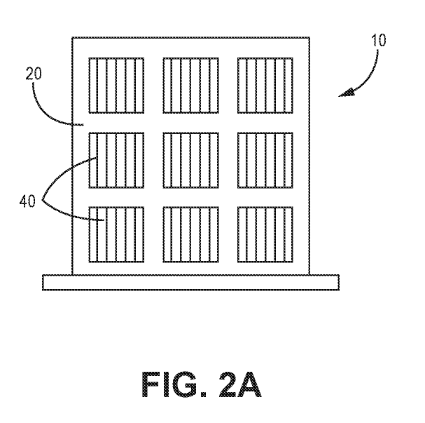

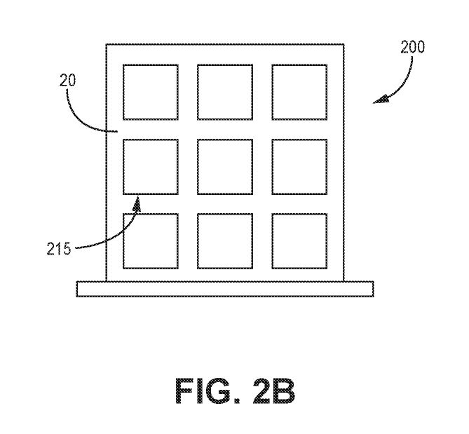

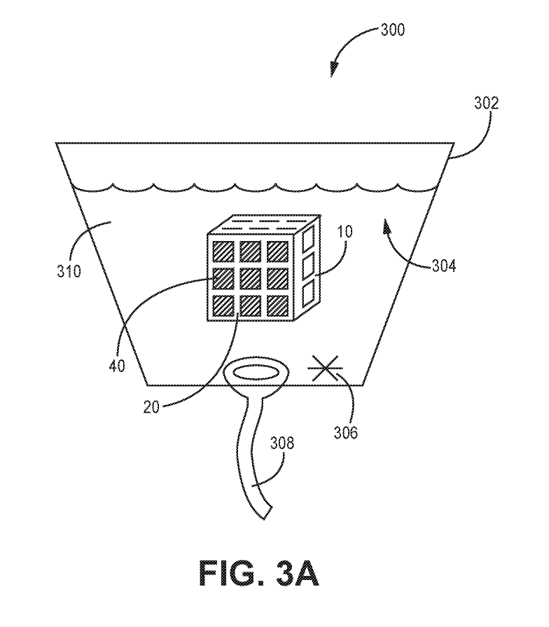

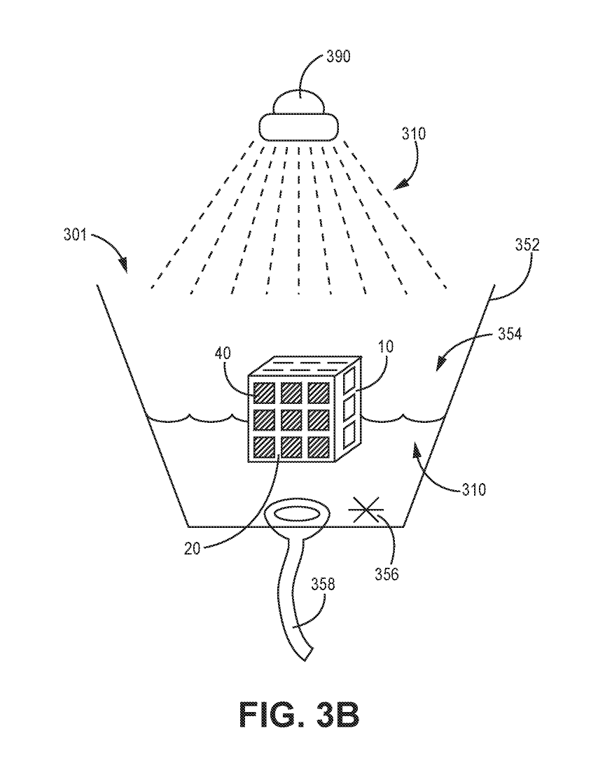

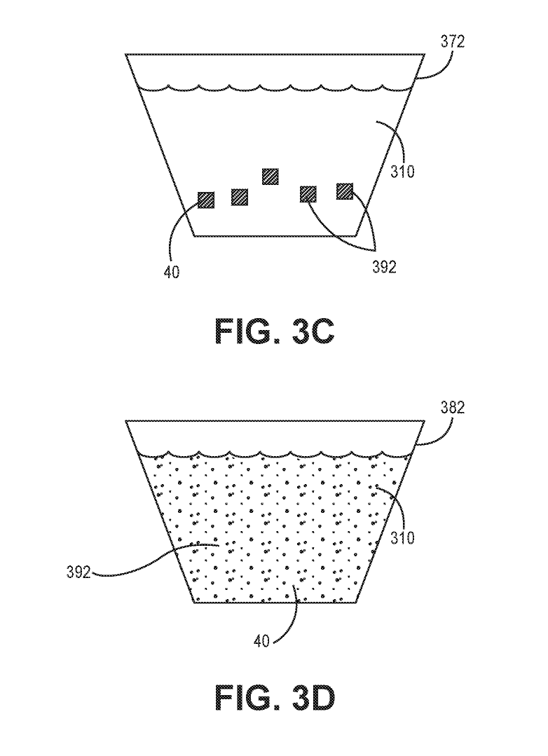

FIG. 2A is a perspective view of a 3D printed part before the support structure has been removed, according to an embodiment. The supported printed object 10 contains both the printed object 20, which is the desired part that is being manufactured. The printed object 20 may be made from Ultem 1010 or Ultem 9085. The supported printed object 10 also includes support structure material 40 that prevents the printed object 20 from being deformed during the printing process. After printing it is desired that the support structure material 40 be removed. The process of removing the support structure material 40 by dissolving the material 40 will be discussed further in relation to FIGS. 3 through 6.

FIG. 2B is a perspective view of a 3D printed part after the support structure has been removed, according to an embodiment. The support material 40 of FIG. 2A has been removed, leaving negative space 215. The printed object 20 may now be used for its intended purpose.

FIG. 3 is a perspective view of a system to remove a support structure from a 3D printed part, according to an embodiment. Once the supported printed object 10 is sufficiently rigid, the support structure 40 can be removed. The support structure 40 can be removed such as by dissolving the support structure 40 using a chemical solvent.

In an embodiment, the printed object 20 may be printed from Ultem 1010 (polyetherimide), the support structure material 40 may be Ultem 1010 Support Material (polyethersulfone), and the chemical solvent can contain N-methyl-2-pyrrolidone. The solvent may include 60-100% N-methyl-2-pyrrolidone by volume, and may optionally include 0-40% carrier solvents by volume. Appropriate carrier solvents may include, e.g., mineral spirits.

In another embodiment, the printed object 20 may be printed from Ultem 1010 (polyetherimide), the support structure material 40 may be Ultem 9085 (polyetherimide alloy), and the chemical solvent can contain N-methyl-2-pyrrolidone. The solvent may include 60-100% N-methyl-2-pyrrolidone by volume, and may optionally include 0-40% carrier solvents by volume. Appropriate carrier solvents may include, e.g., mineral spirits.

In another embodiment, the printed object 20 may be printed from Ultem 9085 (polyetherimide alloy), the support structure material 40 may be Ultem 9085 Support Material (polysulfone), and the chemical solvent can contain N-propyl bromide. The solvent may include 60-100% N-propyl bromide by volume, and may optionally include 0-40% carrier solvents by volume. Appropriate carrier solvents may include, e.g., mineral spirits.

In another embodiment, the printed object 20 may be printed from Ultem 9085 (polyetherimide alloy), the support structure material 40 may be Ultem 9085 Support Material (polysulfone), and the chemical solvent can contain both N-propyl bromide and 1,2 butylene oxide. The solvent may include 60-100% N-propyl bromide by volume, up to 3% 1,2 butylene oxide by volume, and may optionally include 0-40% carrier solvents by volume. Appropriate carrier solvents may include, e.g., mineral spirits.

It has been found that toluene can also be used to dissolve the Ultem 9085 Support Material. However, because toluene is very flammable and toxic, the N-propyl bromide is a much safer alternative.

It is contemplated that a printed object could include more than two types of materials. For example, a printed object could contain a first printing material and a second printing material along with a single support structure material. Alternatively, a printed object could contain a first printing material and a second printing material along with two different support structure materials as described herein. Alternatively, a single printing material could be used with two different support structure materials. Various manufacturing processes may require different combinations of the materials and solvents used herein. Although the embodiments have been described with reference to a single solvent dissolving a single support structure, a supported printed object having two supporting materials could conceivably be exposed to two different chemical solvents to remove the two different supporting materials.

FIG. 3A shows a perspective view of a system 300 to remove a support structure from a 3D printed part, according to an embodiment. The system 300 can include a cleaning vessel 302, such as a vessel where a chemical solvent 310 can be applied to the supported printed object 10 to remove the support structure material 40. The vessel 302 can define a cavity 304. The cavity 304 can at least partially be occupied by the chemical solvent or the 3D printed part, when the system 300 is in use. An agitator 306 can be disposed of within the cavity 304, such as to agitate or recirculate the chemical solvent 310. An agitator 306 can include a propeller or a recirculating pump. The vessel 302 can include a drain 308 to empty the solution. The drain 308 can be coupled to a standard waste water drain. In other implementations the vessel 302 does not contain a drain, but is manually dumped. In an embodiment, the step of removing the support structure using the chemical solvent is performed at a temperature below 100 degrees Fahrenheit. In an alternative embodiment, the step of removing the support structure may be performed at a temperature below 80 degrees Fahrenheit.

In this embodiment, the chemical solvent 310 may completely dissolve the support material 40. Alternatively, the supported printed object 10 can be removed from the solvent 310 while the material 40 has been only partially dissolved, and the support material 40 can be manually picked or scraped away from the desired printed part 20.

It has been found that when using N-propyl bromide to dissolve Ultem 9085 Support Material, the final part can be placed in a ventilated fume, and the chemical solvents will evaporate without further need for rinsing. N-propyl bromide has been listed in the literature as having virtually zero nonvolatile residue content (<10 ppm), it is fast evaporating, non-flammable, and contains no hazardous air pollutants. Therefore the disclosed system and methods are an improved and effective way to remove support structure material from 3D printed parts.

FIG. 3B shows a perspective view of a hemispherical oscillating spray apparatus, according to an embodiment. The system 301 can include a cleaning vessel 352, such as a vessel where a chemical solvent 310 can be applied to the supported printed object 10 to remove the support structure material 40. A hemispherical oscillating spray apparatus 390 may forcibly spray the chemical solvent 310 onto the supported printed part 10, which is made up of both the desired printed object 20 and the support 40. When using the oscillating spray apparatus, it is desirable to expose the support material 40 to the chemical solvent 310 for a relatively longer period of time. For example, the material 40 may be exposed to the chemical solvent 310 for an additional 3 to 6 hours.

In one embodiment, exposing the support material 40 to the chemical solvent 310 using the spray apparatus 390 for an additional 3-6 hours will completely dissolve the material 40, which eliminates the need for a human to manually pick or scrape away the support material 40 from the printed object 20. This allows the printed object 20 to be finished without manual human intervention.

The cavity 354 can at least partially be occupied by the chemical solvent 310 or the 3D printed object 20 when the system 300 is in use. An agitator 356 can be disposed of within the cavity 354, such as to agitate or recirculate the chemical solvent 310. The vessel 352 can include a drain 358 to empty the solution. The drain 358 can be coupled to a standard waste water drain. In other implementations the vessel 352 does not contain a drain, but is manually dumped.

FIG. 3C shows a cleaning vessel 372 after a printed object has been washed to remove support structure material 40. The material 40 is shown in FIG. 3C as solid chunks or large particles 392 that have not been fully dissolved. In an embodiment, these particles 392 can be collected, then dried to remove the chemical solvent 310. The material 40 can then be recycled. It has been found that when Ultem 9085 Support Material is dissolved in either a solvent of N-propyl bromide or N-propyl bromide plus 1,2 butylene oxide, the Ultem 9085 Support Material will remain in particulate form. These particles can be dried and recycled. After processing, the support material can be processed into new support material and reused according to known methods. For the recycling of the 9085 support material, the material does not dissolve in any fashion, it turns into softened material that can be pushed off the part with force and then collected from the parts washer, this material is then dried and crushed as feed stock for new material.

FIG. 3C shows a cleaning vessel 382 after a printed object has been washed to remove support structure material 40. In this embodiment, the material 40 has been completely dissolved and is in suspension in chemical solvent 310. When water is added to the chemical solvent 310 having the suspension 394, the suspended material 394 drops out of suspension. The support material 40 then can be recycled as plastic waste. It has been found that when Ultem 1010 Support Material is dissolved in a solvent of N-methyl-2-pyrrolidone, the Ultem 1010 Support Material dissolves in solution. When water is introduced, the dissolved plastic drops out immediately, and can be recycled as plastic waste.

It has further been found that N-methyl-2-pyrrolidone may be used to completely remove the Ultem 9085 material. This would be required in applications where the 3D printed Ultem 9085 part is used in mold making or carbon wrapping, where after the mold material has been applied to the 3D printed part, the Ultem 9085 is desired to be removed chemically. Temperatures of 180-250 degrees Fahrenheit may be used to accelerate the removal, but this is not required.

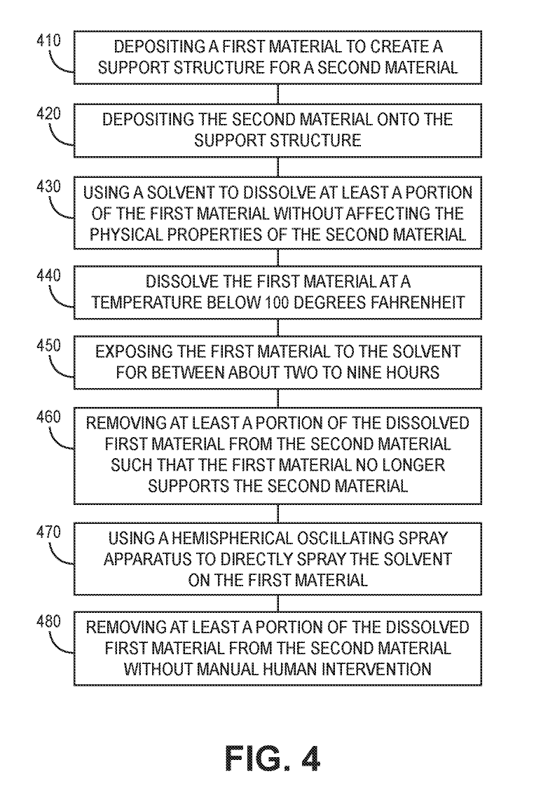

FIG. 4 is a flow chart of a method for forming an object using a 3D printer, according to an embodiment. Step 410 of the method includes depositing a first material to create a support structure for a second material. Step 420 includes depositing the second material onto the support structure. Step 430 includes using a solvent to dissolve at least a portion of the first material without affecting the physical properties of the second material. Step 440 includes dissolve the first material at a temperature below 100 degrees Fahrenheit. Step 450 includes exposing the first material to the solvent for between about two to nine hours. Step 460 includes removing at least a portion of the dissolved first material from the second material such that the first material no longer supports the second material. Step 470 includes using a hemispherical oscillating spray apparatus to directly spray the solvent on the first material. Step 480 includes removing at least a portion of the dissolved first material from the second material without manual human intervention.

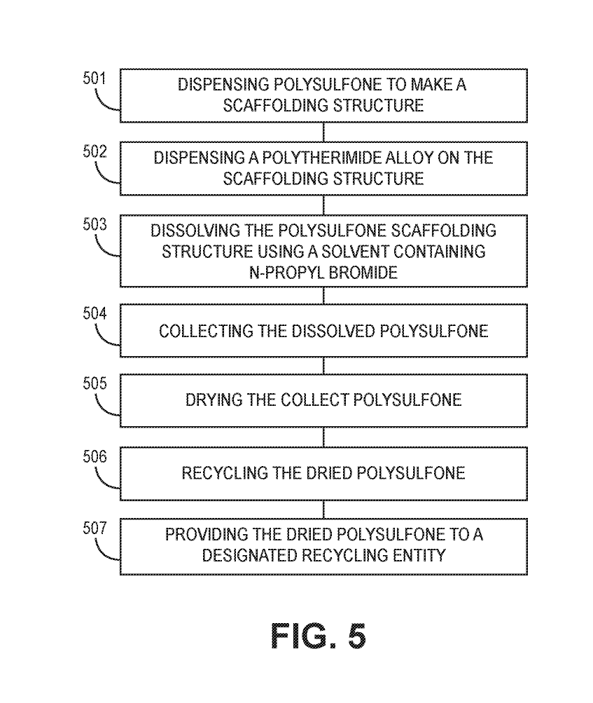

FIG. 5 is a flow chart of a method for reusing a soluble support material for use in 3D printing, according to an embodiment. Step 501 includes dispensing polysulfone to make a scaffolding structure. Step 502 includes dispensing a polyetherimide alloy on the scaffolding structure. Step 503 includes dissolving the polysulfone scaffolding structure using a solvent containing n-propyl bromide. Step 504 includes collecting the dissolved polysulfone. Step 505 includes drying the collected polysulfone. Step 506 includes recycling the dried polysulfone. In optional step 507, the step of recycling the dried polysulfone includes providing the dried polysulfone to a designated recycling entity, wherein the designated recycling entity performs the chemical steps necessary to reuse the polysulfone in 3D printing.

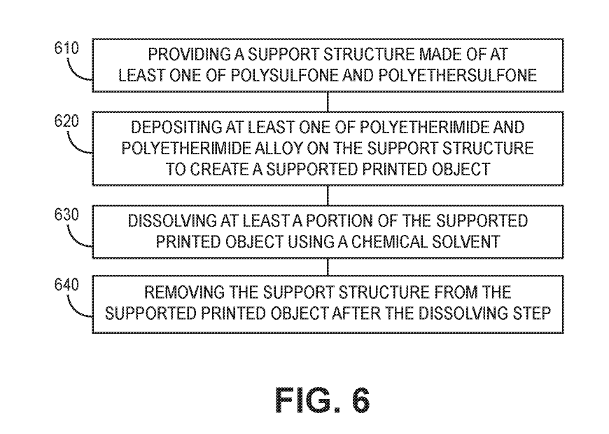

FIG. 6 is a flow chart of a method for forming a three-dimensional object having overhanging portions freely suspended in space, according to an embodiment. Step 610 includes providing a support structure made of at least one of polysulfone and polyethersulfone. Step 620 includes depositing at least one of polyetherimide and polyetherimide alloy on the support structure to create a supported printed object. Step 630 includes dissolving at least a portion of the supported printed object using a chemical solvent. Step 640 includes removing the support structure from the supported printed object after the dissolving step.

The disclosed embodiments have been described with reference to various specific and preferred embodiments and techniques. However, it should be understood that many variations and modifications may be made while remaining within the spirit and scope of the invention.

1. A method of forming an object using a 3D printer, the method comprising:
depositing a first material to create a support structure for a second material;
depositing the second material onto the support structure;
using a solvent to dissolve at least a portion of the first material without affecting the physical properties of the second material; and
removing at least a portion of the dissolved first material from the second material such that the first material no longer supports the second material;
wherein the first material comprises polyethersulfone, the second material comprises polyetherimide, and the solvent comprises N-methyl-2-pyrrolidone.

2. The method of claim 1, wherein the solvent comprises about between 60-100% N-methyl-2-pyrrolidone and about between 0-40% carrier solvents by volume.

3. The method of claim 1, wherein the step of using the solvent to dissolve the first material includes exposing the first material to the solvent for between about two to nine hours.

4. The method of claim 1, wherein the step of using a solvent to dissolve the first material is performed at a temperature below 100 degrees Fahrenheit.

5. The method of claim 1, wherein the step of using a solvent to dissolve at least a portion of the first material further comprises:
using a hemispherical oscillating spray apparatus to directly spray the solvent on the first material; and
exposing the first material to the solvent for between about two and nine hours;
wherein the step of removing at least a portion of the dissolved first material from the second material occurs without manual human intervention.

6. A method of forming an object using a 3D printer, the method comprising:
depositing a first material to create a support structure for a second material;
depositing the second material onto the support structure;
using a solvent to dissolve at least a portion of the first material without affecting the physical properties of the second material; and
removing at least a portion of the dissolved first material from the second material such that the first material no longer supports the second material;
wherein the first material comprises polysulfone, the second material comprises polyetherimide alloy, and the solvent comprises N-propyl bromide.

7. The method of claim 6, wherein the solvent comprises about between 60-100% N-propyl bromide and about between 0-40% carrier solvents by volume.

8. The method of claim 6, wherein the solvent comprises up to 3% 1,2 butylene oxide by volume.

9. The method of claim 6, wherein the step of using the solvent to dissolve the first material includes exposing the first material to the solvent for between about two to nine hours.

10. The method of claim 6, wherein the step of using a solvent to dissolve the first material is performed at a temperature below 100 degrees Fahrenheit.

11. The method of claim 6, wherein the step of using a solvent to dissolve at least a portion of the first material further comprises:
using a hemispherical oscillating spray apparatus to directly spray the solvent on the first material; and
exposing the first material to the solvent for between about two and nine hours;
wherein the step of removing at least a portion of the dissolved first material from the second material occurs without manual human intervention.

12.-19. (canceled)

20. A method for reusing a soluble support material for use in three-dimensional printing, the method comprising:
dispensing polysulfone to make a scaffolding structure;
dispensing a polyetherimide alloy on the scaffolding structure;
dissolving the polysulfone scaffolding structure using a solvent containing N-propyl bromide;
collecting the dissolved polysulfone;
drying the collected polysulfone; and
recycling the dried polysulfone.

21. The method of claim 20, wherein the solvent contains at least 60% N-propyl bromide by volume, and the solvent further comprises 1,2 butylene oxide.

22. The method of claim 20, wherein the step of dissolving the support structure material is performed at a temperature below 100 degrees Fahrenheit.

23. The method of claim 20, wherein the step of recycling the dried polysulfone comprises providing the dried polysulfone to a designated recycling entity, wherein the designated recycling entity performs the chemical treatment necessary to reuse the polysulfone.

24.-25. (canceled)
